(19) United States
(12) Patent Application Publication
(10) Pub. No.: US 2010/0056034 A1
(43) Pub. Date: Mar. 4, 2010

(54) Smoker's Enclosure

(76) Inventor: David N. Pilkinton, Farmington Hills, MI (US)

Correspondence Address: YOUNG BASILE, 3001 WEST BIG BEAVER ROAD, SUITE 624, TROY, MI, 48084, US

(21) Appl. No.: 12/203,240

(22) Filed: Sep. 3, 2008

(51) Int. Cl. B08B 15/02

(52) U.S. Cl. 454/67

(57) ABSTRACT

A coin operated smoker's enclosure in the form of an upright booth with polycarbonate walls, aluminum framing and a hinged door. An air recirculation system provides treated air within the enclosure as well as carbon monoxide and smoke detection. An air exhaust system filters the air for particulate matter before exhausting it from the enclosure. The coin acceptor is wired to turn on the various electrically powered devices only when the appropriate coin requirements are met. An upright compartment in one corner of the enclosure houses all of the active components and is accessible from the outside of the enclosure.

### FIELD OF THE INVENTION

This invention relates to an enclosure for safely and comfortably accommodating one or more smokers in an isolated environment and more particularly, to such an enclosure which has one or more air conditioning systems and an entry system which may be coin operated.

### BACKGROUND OF THE INVENTION

There are many venues, including restaurants and public buildings, where smoking is either severely restricted or banned entirely. In such venues, a person desiring to enjoy a cigarette or the like is often required to go outdoors or otherwise suffer significant inconvenience in order to satisfy the desire to smoke.

Some devices including partial enclosures have been contrived to isolate a smoker to at least some degree from his or her surroundings; see for example, U.S. Pat Nos. 5,085,134 and 6,039,776. However, none of these contrivances is entirely satisfactory or practical.

### SUMMARY OF THE INVENTION

The present invention provides a full enclosure for one or more persons which can be conveniently located indoors or outdoors and which provides a comfortable and safe environment for smoking activity while, at the same time, fully isolating the smoker and protecting nearby persons from secondhand smoke. In general, the invention comprises a booth-type compartment of sufficient size to accommodate at least one full-grown human person in both standing and seated positions. The enclosure typically has a floor, ceiling, sidewalls and an entry door which permits standup entry into the enclosure and which, in the preferred embodiment, is translucent so as to avoid the claustrophobic effects of being in an enclosure with completely opaque outer walls.

In accordance with the invention, the enclosure is provided with an air recirculation system comprising at least a fan and a filter, and also with an air exhaust system comprising a fan and a filter. Finally, the enclosure is provided with an entry/activation system which, for example, may be coin or token operated, for activating the recirculation and exhaust systems as well as any other electrical appliances such as a timer added to the enclosure as optional features.

In the preferred embodiment hereinafter described, the air recirculation system is provided for the purpose of monitoring and treating air within the enclosure. An alarm will sound if harmful effects of smoke or carbon dioxide are detected. The air is treated with antibacterial ultraviolet light and ionic filtering. Air is then heated as appropriate and returned to the enclosure. Outside 110V AC power is brought to the electrical devices through a ground fault protector. The various components of the most complete illustrative system include an ionic filter, a smoke detector, an antibacterial UV light, a carbon monoxide detector with display, a light or multiple lights, a power inlet with ground fault, a light window or ceiling, a vent, a cover and a heater. The entry/activation system accepts coins and turns all systems on for a predetermined period.

Also in accordance with the well-equipped, preferred embodiment, the function of the exhaust system is to pull air from the enclosure through filters such as carbon and HEPA filters and then exhaust the filtered air outside of the enclosure. The enclosure is constructed in such a way that it is not air tight; therefore, the exhaust system creates a slightly negative air pressure within the chamber which prevents smoke leakage and also draws some fresh air into the chamber through door gaps and hinges. It also pulls air through the filter. The filter may be wired to a coin acceptor to prevent usage of the enclosure unless the filters are installed. The components comprise charcoal and HEPA filters, a fan, a filter-present detector (such as a limit switch), an exhaust vent and an intake vent.

As indicated above, all illustrative embodiment of the invention uses a coin acceptor for activation of the various systems. Thus, the enclosure can be used as a revenue generating device. The coin acceptor is wired to turn on power to all of the filters and lights and also, to activate a timer which indicates the remaining time for use of the enclosure and, if desired, may issue a warning for the last sixty seconds. Coins are collected in a tray. If desired, a door lock may be provided which will prevent entry to the enclosure when it is not in use.

In the preferred embodiment, all of the active components of the recirculation and exhaust systems are packaged in a vertical compartment which is located in a front corner of the enclosure adjacent the door. The compartment is provided with a key-lockable outside door so that it can be accessed by authorized persons for servicing of the components as well as emptying the ash receptacle and collecting coins and/or tokens from the coin/token acceptor.

In the preferred form, the enclosure is approximately 32 inches by 32 inches in cross-section and therefore has a footprint area of less than 9 square feet. It is made of fire-resistant and corrosion-resistant aluminum and polycarbonate components. The enclosure is modularized so that it may be expanded to two, three or more person capacity.

### DETAILED DESCRIPTION THE DRAWINGS

The description herein makes reference to the accompanying drawings wherein like reference numerals refer to like parts throughout the several views and wherein:

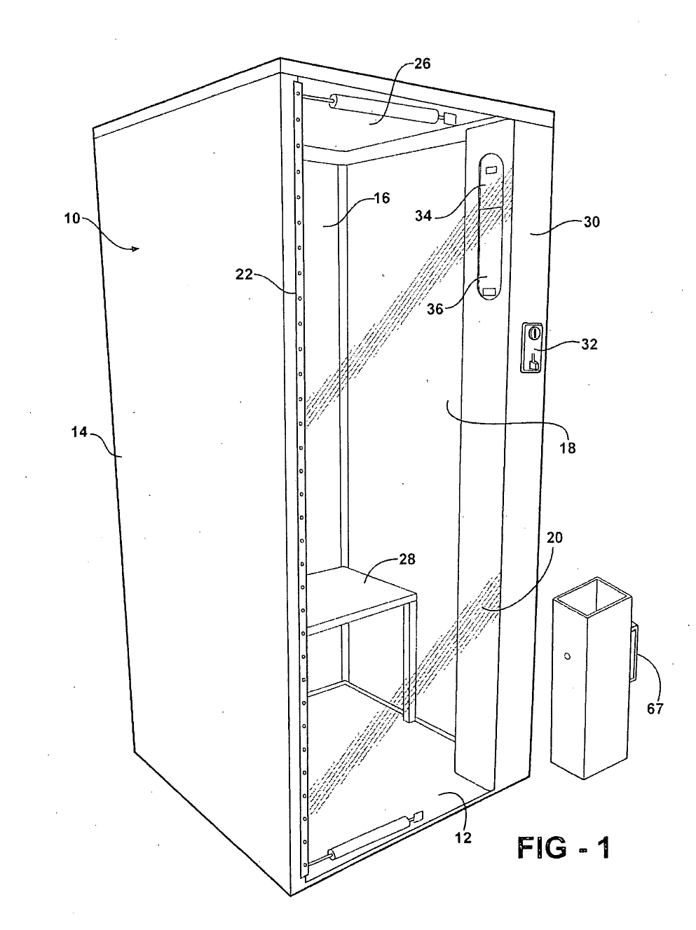

FIG. 1 is a perspective view of an embodiment of the invention;

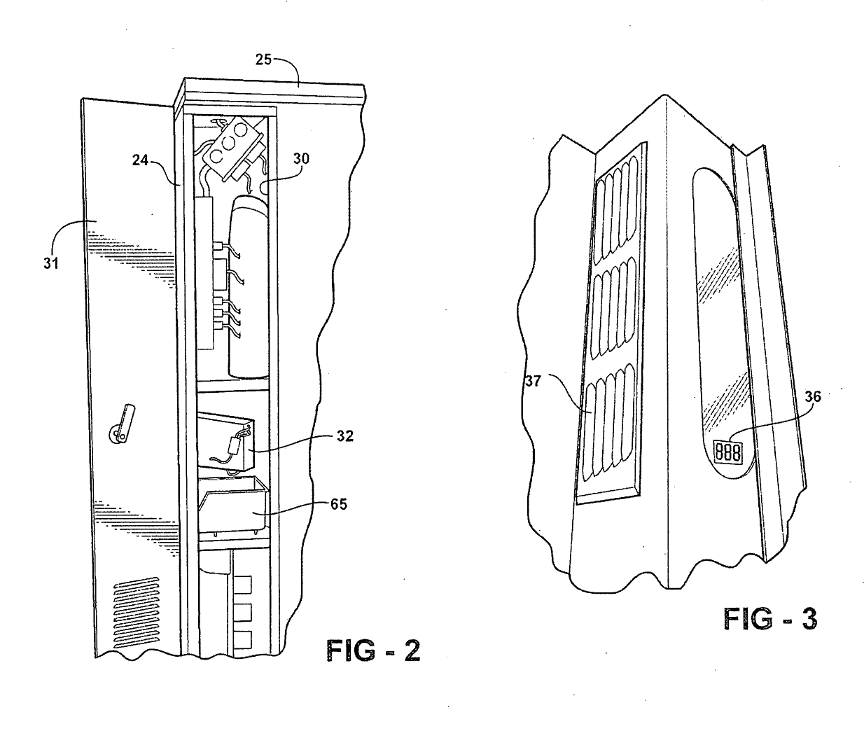

FIG. 2 is a view of the compartment which houses systems components;

FIG. 3 shows a vent and display; and

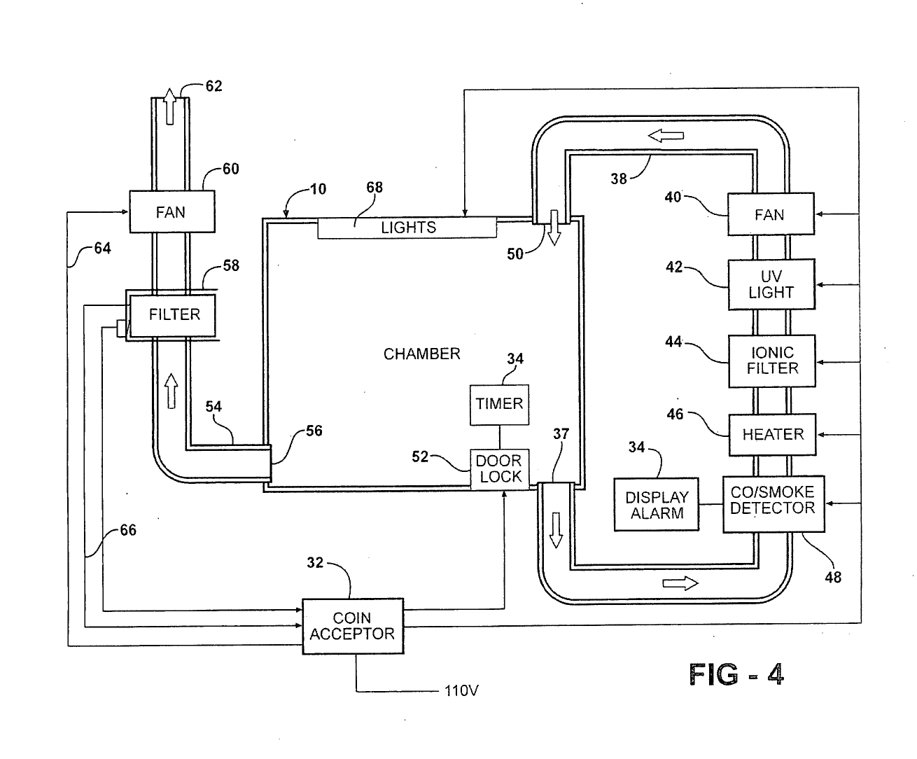

FIG. 4 is a system diagram.

### DETAILED DESCRIPTION OF THE ILLUSTRATIVE EMBODIMENT

Referring to the drawings, FIG. 1 shows an upright, square booth-style enclosure 10 comprising an aluminum floor 12 of 32-inch by 32-inch dimensions. In addition, the enclosure comprises walls, 14, 16, 18 made of opaque polycarbonate material and a see-through polycarbonate door 20 having a vertical piano-type hinge 22 connected to an aluminum corner post 24. The entire structure is assembled using either angle-iron or box-section aluminum corner posts 24 as well as horizontal side corner members 25. The structure is easily assembled using screws or rivets as will be apparent to those skilled in the art. A light transmitting domed ceiling 26 is secured in place over the top of the enclosure. A seat 28 is mounted on the floor 12 against the back wall 16 of the enclosure at an appropriate seat height for adult persons. The overall enclosure height can be on the order of 6½ to 7 feet so as to accommodate a full grown human in both standing and seated positions and the full height entry door 20 admits full grown humans in a walk-in, stand-up fashion.

A vertical compartment 30 is formed in the right forward corner by aluminum plates and is provided with a hinged outside access door 31. The purpose of the compartment 30 is to house the components of air recirculation and exhaust systems as hereinafter described. A coin acceptor 32 is mounted on the front panel of the compartment 30 beside door 20 to receive coins and to activate the electrically-powered components of the various systems as hereinafter described.

It will be understood that, while the enclosure 10 is shown of a size suitable for accommodating one person, it is essentially modular in design and may easily be expanded to multiples in width to accommodate two or more persons either in a common interior space or in separately divided spaces with their own individual doors. Many variations on the theme will be apparent to those skilled in the art.

Referring now to FIGS. 3 and 4, the operating systems provided for the deluxe version of the enclosure 10 will be described. First, an air recirculation system comprises an air flow path 38 through the compartment 30 having an intake vent 37, a fan 40, a biocidal UV light 42, an ionic filter 44, an optional electric heater 46 and smoke and carbon monoxide detectors 48 having a display 34. All of the above-described components are connected to 110 volt AC power source through the coin acceptor 32 such that they are powered-up only when the appropriate entry fee money is inserted. In addition, the coin acceptor is connected to activate a timer 39 having a digital display 36 which is visible from the inside of the enclosure 10 to show time remaining as indicated in FIG. 3.

The coin acceptor 32 can also be connected to a door lock 52 if it is desired to limit access to the chamber or enclosure 10 during periods of non-use. This may not be necessary if the enclosure 10 is used in a controlled access venue such as the interior of a restaurant or other private business.

The air recirculation system is provided with an outlet 50 which returns air back into the enclosure 10.

The air exhaust system comprises a duct 54 which also extends through the vertical compartment 30 between an intake 56 and an exhaust 62 which is exterior of the enclosure 10. The exhaust system is provided with a filter 58 and a fan 60. The fan 60 is connected by wires 64 to the coin acceptor 32 to be activated only when coins are dropped into the coin acceptor to start a utilization period. The filter compartment 58 is preferably provided with a limit switch (not shown) or other proximity detector to provide a signal over wire 66 to the coin acceptor to disable the device unless a filter is in place. Filter 44 may be similarly wired.

A coin tray 65 is disposed in compartment 30. A sheet metal ash receptacle 67 is located in the lower portion of the vertical compartment 30 and is accessible through a small hole from the inside of the enclosure to dispose of ashes and cigarette butts. It is also accessible through the outside door 31 so that it may be emptied from time to time.

The filter 44 is preferably of the ionic type. Smoke and carbon dioxide detectors 48 are provided to treat the recirculated air to make sure that harmful levels of smoke and carbon monoxide are detected and an appropriate display or alarm provided. A light such as a rope light 68 is also provided to be activated by the coin acceptor 32 and is preferably mounted on the inside perimeter of the enclosure 10 near the top. The heater is preferably on the order of 500 watts and may be provided by a suitable blower as will be apparent to those skilled in the art.

The coin acceptor 32 may be a Wavefuture Ah5 coin acceptor with a power control board and a coin tray. The door lock 52 may be of the solenoid type.

As indicated above, the function of the air exhaust system 54, 58, 60, is to pull air from the enclosure through carbon and HEPA filters 58 and exhaust the filtered air outside of the enclosure. The fan 60 pulls a high volume of air which creates a slight vacuum within the enclosure to prevent leakage of smoke. With the door closed, the air will be primarily be pulled through the filters 58.

There are numerous advantages to the invention including the fact that it may pay for itself by collecting user fees. Patrons of the business in which the enclosure is located will not have to exit the building or suffer inconvenience or exposure to the weather. An ash receptacle of suitable size will collect hundreds of cigarette butts, thus limiting the service intervals and service times of the enclosure, if mounted outside. The enclosure provides shelter from rain, wind and cold weather. The interior air is treated with antibacterial UV light and an ionic filter for health purposes, and the interior air is constantly monitored during periods of use for carbon monoxide and excessive smoke. The fans are preferably “muffin” fans, which are quiet in operation.

The coin acceptor 32 may, of course, be replaced with numerous devices, including a pushbutton timer wherein patrons are provided with an appropriate code. Lighting may be white or colored, and graphics may be applied to various panels of the enclosure. A rubber mat or carpeting may be applied to the floor and the unit may be mounted on roller casters, if desired.

It will be understood that the invention has been described with respect to a single illustrative embodiment, but variations and modifications as described herein as well as those not described herein will be apparent to persons skilled in the art.

What is claimed is:

1. A smoker's enclosure comprising:
a fully enclosed chamber of sufficient size to accommodate a full grown human in both standing and seated positions and having a floor, a ceiling, sidewalls and an entry door;
an air recirculation system for said chamber comprising a fan and a filter;
an air exhaust system for said chamber comprising a fan and a filter; and
an activation system for activating said air recirculation and exhaust systems.

2. A smoker's enclosure as defined in claim 1 wherein the recirculation system includes a UV bactericidal light.

3. A smoker's enclosure as defined in claim 1 wherein the air recirculation system includes a carbon monoxide detector.

4. A smoker's enclosure as defined in claim 1 wherein the air recirculation system includes a heater.

5. A smoker's enclosure as defined in claim 1 wherein the activation system includes a timer.

6. A smoker's enclosure as defined in claim 5 wherein the timer includes a time remaining display which is visible from within the enclosure.

7. A smoker's enclosure as defined in claim 1 wherein the activation system comprises a coin acceptor.

8. A smoker's enclosure as defined in claim 7 wherein the coin acceptor is connected to activate the fans.

9. A smoker's enclosure as defined in claim 1 further comprising a lock on the entry door, said activation system being connected to said lock to permit entry to the enclosure.

10. A smoker's enclosure as defined in claim 1 wherein the enclosure is provided with a seat.

11. A smoker's enclosure as defined in claim 1 wherein the enclosure is provided with a light.

12. A smoker's enclosure as defined in claim 1 further including an ash receptacle.

13. A smoker's enclosure as defined in claim 1 wherein the door is translucent.

14. A smoker's enclosure as defined in claim 1 wherein the chamber is constructed with a vertical compartment having a door which can be opened from the outside of the container, said compartment containing the operating components of the air recirculation system and the air exhaust system.

15. A smoker's enclosure as defined in claim 14 wherein the compartment further houses an ash receptacle.

16. A controlled-access enclosure for accommodating a smoker comprising:
a standing-height booth with sidewalls, floor, ceiling and a door;
an air system for clearing the interior of the booth of smoke; and
an access-control mechanism such as a coin acceptor for selectively controlling the door and activating the air system for a predetermined time.
